(19) United States
(12) Patent Application Publication
(10) Pub. No.: US 2001/0018910 A1
(43) Pub. Date: Sep. 6, 2001

(54) Fuel injection apparatus in internal combustion engine

(76) Inventor: Kenichi Nomura, Yokohama-Shi (JP)

Correspondence Address: JOSEPH J. ZITO, 1300 I STREET, N.W., 11TH FLOOR EAST, WASHINGTON, DC, 20005-3314, US

(21) Appl. No.: 09/778,141

(22) Filed: Feb. 7, 2001

(30) Foreign Application Priority Data
Mar. 1, 2000 (JP) 2000-55246

(51) Int. Cl. F02M 37/04; F02M 1/00

(52) U.S. Cl. 123/510; 123/41.01

(57) ABSTRACT

The invention provides a fuel injection apparatus in an internal combustion engine for an outboard machine which improves a pump performance of the high pressure fuel pump and accurately and stably supplies a fuel from a fuel injection valve. There is provided an injection fuel flow passage system in which a fuel within a vapor separator V is sucked and discharged by a high pressure fuel pump, a high pressure fuel discharged from the high pressure fuel pump is supplied to a fuel distribution pipe provided with a fuel injection valve and a return fuel of a pressure regulator connected to the fuel distribution pipe is returned into the vapor separator via a return fuel passage. A heat exchanger is arranged in the injection fuel flow passage system, and a cooling water branched from a discharge passage of a cooling water pump for cooling an engine is supplied to the heat exchanger via a cooling water introduction passage and is discharged toward the outside via a cooling water discharge passage.

### BACKGROUND OF THE INVENTION

1. Field of the Invention

The present invention relates to a fuel injection apparatus in an internal combustion engine for an outboard machine which increases a pressure of a fuel within a fuel source to a low pressure by a low pressure fuel pump so as to supply into a vapor separator, stores a fixed amount of fuel within the vapor separator, increases a pressure of the fuel within the vapor separator to a high pressure by a high pressure fuel pump so as to supply to a fuel distribution pipe, and injects and supplies the high pressure fuel from a fuel injection valve attached to the fuel distribution pipe toward an engine.

2. Description of the Conventional Art

A description will be given of a fuel injection apparatus in a conventional internal combustion engine for an outboard machine with reference to FIG. 6. The internal combustion engine for the outboard machine will be simply referred to as an engine in the following description.

Reference symbol T denotes a fuel source. A fuel is stored within the fuel source. Reference symbol PL denotes a low pressure fuel pump which increases a pressure of the fuel within the fuel source T to a low pressure (for example, 0.3 kg/cm²) so as to discharge. Then, the fuel source is arranged in a hull side.

Reference symbol V denotes a vapor separator which stores a fixed amount of fuel therein and separates a gas contained in the fuel. The vapor separator V is provided with the following elements.

Reference numeral 50 denotes a constant liquid surface apparatus. The constant liquid surface apparatus is constituted of a valve seat 51 on which a seat hole 51A communicating with a discharge hole of the low pressure fuel pump PL is pierced, a float valve 52 for opening and closing the seat hole 51A of the valve seat 51, and a float 54 rotatably pivoted by a shaft 53 and provided with a float arm 54A facing to the float valve 52.

In this case, in a state that the fuel is not stored within the vapor separator V, the float 54 including the float arm 54A is in a state of rotating in a counterclockwise direction with reference to the shaft 53 and the float valve 52 comes off from the valve seat 51 to make the seat hole 51A open.

In this state, when the low pressure fuel pump PL is driven and pressure of the fuel within the fuel source T is increased to the low pressure and supplied to the seat hole 51A, the low pressure fuel gradually flows into the vapor separator V via the seat hole 51A and the fuel liquid surface thereof is ascended. Accordingly, the float 54 gradually rotates in a clockwise direction in the drawing. When the float 54 reach a fixed fuel liquid surface level, the float arm 54A moves the float valve 52 upward so as to close the seat hole 51A and shut a fuel supply from the low pressure fuel pump PL, thereby storing a fixed amount of fuel within the vapor separator.

Reference symbol PH denotes a pump which increases a pressure of the fuel within the vapor separator V to a high pressure (for example, 3 kg/cm²) so as to discharge. For example, a wesco type high pressure fuel pump is employed.

Reference symbol D denotes a fuel distribution pipe provided with a fuel distribution passage DA therein. A plurality of fuel injection valves J for injecting and supplying a controlled fuel toward an intake pipe 55 communicating with an engine (not shown) are attached to the fuel distribution pipe D. (In the drawing, a single fuel injection valve J is shown.)

Reference symbol R denotes a pressure regulator for keeping the fuel pressure constant with respect to the atmospheric pressure or a negative pressure of the intake pipe. An inlet RA of the pressure regulator R is communicated with the fuel distribution passage DA and an outlet RB thereof is connected to an inner portion of the vapor separator V via a return fuel passage 56.

A description will be given of a flow of the fuel. A first fuel flow corresponds to a low pressure fuel flow, and constitutes a flow among the fuel source T, the low pressure fuel pump PL and the vapor separator V.

Further, a second fuel flow corresponds to a high pressure fuel flow, and constitutes a flow among the high pressure fuel pump PH, the fuel distribution pipe D, the pressure regulator R and the vapor separator V.

Further, the fuel within the fuel distribution passage DA of the fuel distribution pipe D is injected toward the inside of the intake pipe 55 via the fuel injection valve J. Further, the vapor separator V including the high pressure fuel pump PH, the fuel distribution pipe D and the pressure regulator R are arranged within a cowling of the engine.

In accordance with the conventional fuel injection apparatus mentioned above, it is impossible to prevent the temperature of the fuel within the vapor separator V from being increased.

That is, the high pressure fuel discharged from the high pressure fuel pump PH is supplied to the fuel distribution passage DA of the fuel distribution pipe D, the fuel within the fuel distribution passage DA is controlled by the fuel injection valve J so as to be injected and supplied from the fuel injection valve J toward the intake pipe 55, and the remaining fuel is again returned into the vapor separator V via the return fuel passage 56 of the pressure regulator R.

Here, paying attention to a low opening degree operation such as an engine idling operation, an amount of fuel consumed and supplied from the fuel injection valve J toward the intake pipe 55 is just a part of the fuel discharged from the high pressure fuel pump PH, and a great part of the fuel is again returned into the vapor separator V via the pressure regulator R and the return fuel passage 56.

On the other hand, the second fuel flow mentioned above (the flow among the high pressure fuel pump PH, the fuel distribution pipe D, the pressure regulator R and the vapor separator V) is done within the cowling of the engine.

In accordance with the structure mentioned above, since the temperature of the fuel is increased due to an influence of a heat generated in the engine and the fuel at the low opening degree operation continuously circulates among the vapor separator V, the high pressure fuel pump HP, the fuel distribution pipe D, the pressure regulator R and the vapor separator V when the second fuel flow passes within the cowling of the engine, the temperature of the fuel within the vapor separator V is increased.

As a result of the temperature of the fuel within the vapor separator being increased, the high pressure fuel pump PH has to suck and discharge the fuel in a high temperature state, and can not properly pressurize and feed the fuel.

In particular, in the case of employing the wesco type fuel pump, a cavitation is easily generated.

Further, since the high pressure fuel pump generally employs an electrically driven type fuel pump using a motor and a coil portion of the motor generates heat, the temperature of the fuel is further increased at a time of sucking and discharging the fuel in the high temperature state mentioned above. Accordingly, bubbles are easily generated in the fuel. When the fuel containing the bubbles is supplied to the fuel injection valve J, it is impossible to accurately supply the fuel from the fuel injection valve J.

### SUMMARY OF THE INVENTION

The present invention is made by taking the problems mentioned above into consideration, and an object of the present invention is to provide a fuel injection apparatus in an internal combustion engine for an outboard machine which can restrict an increased of temperature of a fuel stored within a vapor separator by positively reducing a temperature of a fuel flowing through an injection fuel flow passage system circulating among a high pressure fuel pump, a fuel distribution pipe and a pressure regulator, thereby improving a pump performance of the high pressure fuel pump and accurately supplying a fuel from the fuel injection valve.

In order to achieve the object mentioned above, in accordance with a first aspect of the present invention, there is provided a fuel injection apparatus in an internal combustion engine for an outboard machine comprising:

a high pressure fuel pump arranged within a vapor separator for storing a fixed amount of low pressure fuel supplied from a low pressure fuel pump therein; and

an injection fuel flow passage system for supplying a high pressure fuel discharged from the high pressure fuel pump to a fuel distribution pipe provided with a fuel injection valve and returning a return fuel in a pressure regulator connected to the fuel distribution pipe into the vapor separator via a return fuel passage,

wherein a heat exchanger is arranged in the injection fuel flow passage system, and a cooling water branched from a discharge passage of a cooling water pump for cooling an engine is supplied to the heat exchanger via a cooling water introduction passage and is discharged toward the outside via a cooling water discharge passage, thereby cooling the fuel flowing within the injection fuel flow passage system.

Further, in addition to the first aspect mentioned above, in accordance with a second aspect of the present invention, there is provided a fuel injection apparatus in an internal combustion engine for an outboard machine as recited in the first aspect, wherein the fuel distribution pipe constituting the injection fuel flow passage system has a fuel distribution passage, and a cooling water flow passage corresponding to a heat exchanger surrounding the fuel distribution passage, which are formed within the fuel distribution pipe in a separate manner, a fuel supply passage connected to at least the high pressure fuel pump is connected to the fuel distribution passage, an injection valve supporting hole for inserting and supporting the fuel injection valve is provided in the fuel distribution passage in an open manner, and a cooling water introduction passage connected to a discharge passage of the cooling water pump and a cooling water discharge passage toward the outside are connected to the cooling water flow passage.

Further, in addition to the second aspect mentioned above, in accordance with a third aspect of the present invention, there is provided a fuel injection apparatus in an internal combustion engine for an outboard machine as recited in the second aspect, wherein the cooling water discharge passage is connected to a portion near a discharge hole of a pilot cooling water passage which is discharged toward the outside from the discharge passage of the cooling water pump without passing through the engine.

Further, in addition to the second aspect mentioned above, in accordance with a fourth aspect of the present invention, there is provided a fuel injection apparatus in an internal combustion engine for an outboard machine as recited in the second aspect, wherein a primary side pilot cooling water passage connected to the discharge passage of the cooling water pump and a secondary side pilot cooling water passage connected to the discharge hole are connected to the cooling water flow passage, the cooling water is supplied to the cooling water flow passage via the primary side pilot cooling water passage, and the cooling water within the cooling water flow passage is discharged to the outside via the secondary side pilot cooling water passage.

In accordance with the first aspect mentioned above, since the heat exchanger is arranged in the injection fuel flow passage system, and a seawater serving as the cooling water is supplied to the heat exchanger from the cooling water pump for cooling the engine, the fuel returning to the vapor separator is cooled, whereby an increase of the temperature of the fuel within the vapor separator can be restricted.

Accordingly, it is possible to improve a pump performance of the high pressure fuel pump, it is possible to reduce bubbles generated by the high pressure fuel pump, and it is possible to achieve an accurate fuel control of the fuel injection valve.

Further, in accordance with the second aspect, since the heat exchanger is integrally formed with the fuel distribution pipe and formed as the cooling water flow passage surrounding the fuel distribution passage in a separate manner, it is possible to improve a freedom for design of the heat exchanger, it is possible to inexpensively provide the apparatus, and it is possible to further improve a fuel cooling effect within the fuel injection flow passage system.

Further, in accordance with the third aspect, since the discharge side end portion of the cooling water discharge passage is connected to the portion near the discharge hole of the pilot cooling water passage, it is possible to improve a freedom for design of the cooling water discharge passage.

Further, in accordance with the fourth aspect, since the cooling water is supplied and discharged to the cooling water flow passage serving as the heat exchanger by using the pilot cooling water passage, it is possible to further improve a freedom for design of the cooling water introduction passage and the cooling water discharge passage and it is possible to effectively reduce a producing cost.

### BRIEF DESCRIPTION OF THE DRAWINGS

FIG. 1 is a schematic cross sectional view of a main portion showing an embodiment of a fuel injection apparatus in an internal combustion engine for an outboard machine in accordance with the present invention;

FIG. 2 is a vertical cross sectional view of a main portion showing an embodiment of a heat exchanger in FIG. 1;

FIG. 3 is a schematic cross sectional view of a main portion showing another embodiment in accordance with the present invention;

FIG. 4 is a vertical cross sectional view along a line X-X in FIG. 3;

FIG. 5 is a schematic cross sectional view of a main portion showing the other embodiment in accordance with the present invention; and

FIG. 6 is a schematic cross sectional view of a main portion showing a fuel injection apparatus in a conventional internal combustion engine for an outboard machine.

### DESCRIPTION OF THE PREFERRED EMBODIMENTS

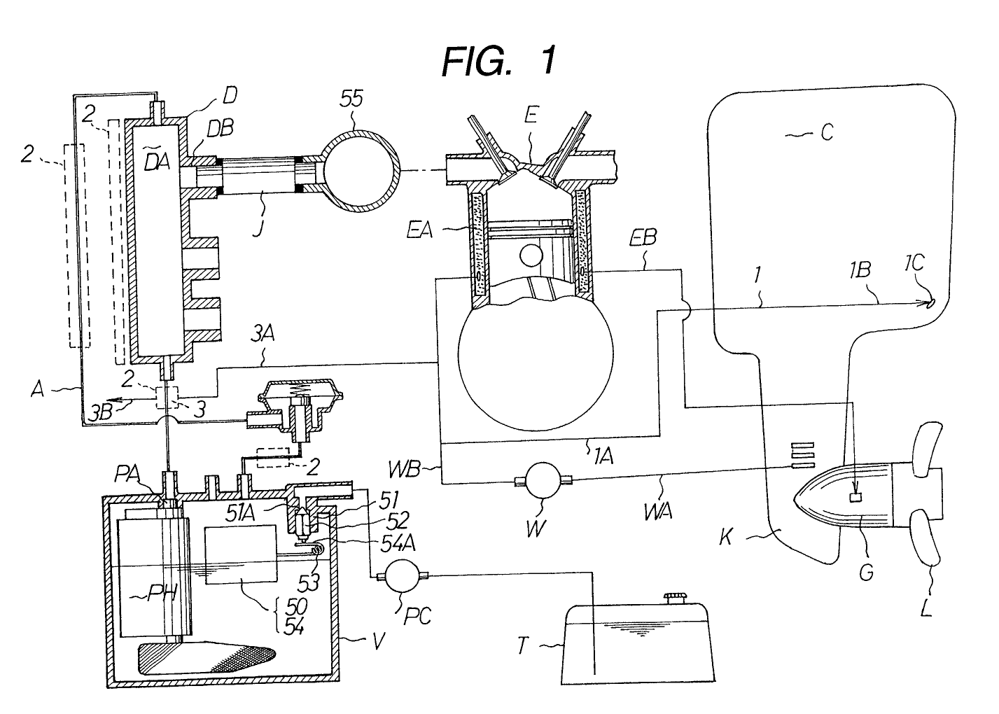

A description will be given below of an embodiment of a fuel injection apparatus in an internal combustion engine for an outboard machine in accordance with the present invention with reference to FIG. 1.

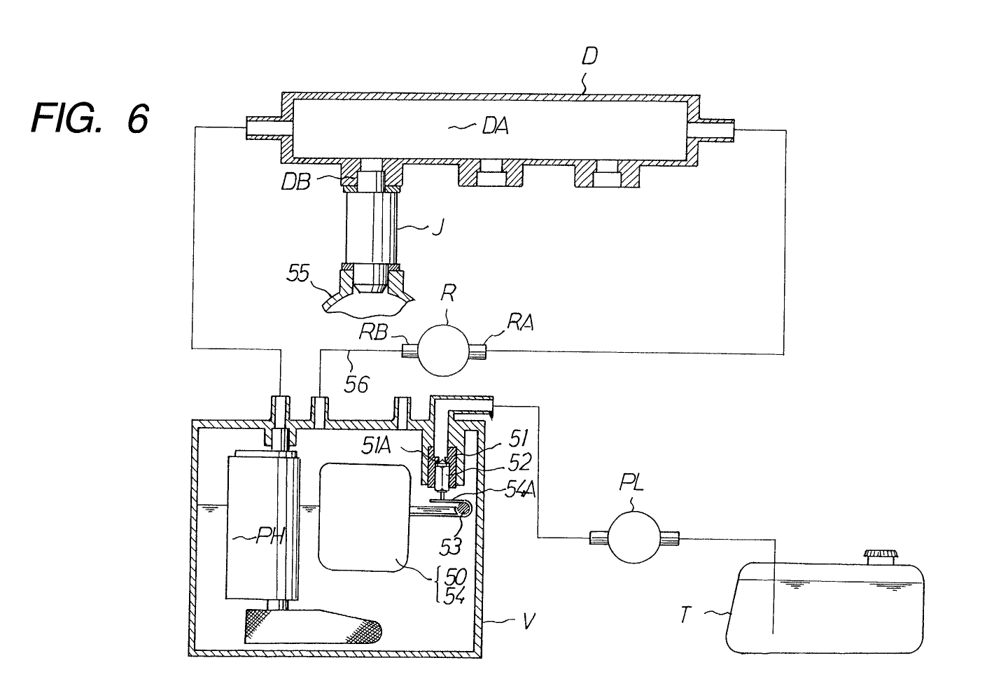

In this case, the same reference symbols are used for the same elements as those in FIG. 6.

Pressure of a fuel stored within a fuel source T is increased to a low pressure by a low pressure fuel pump PL, and is supplied into a vapor separator V via a seat hole S5A of a valve seat 51, and a fixed amount (a fixed liquid surface) of fuel is stored within the vapor separator V by a constant liquid surface apparatus 50 constituted of the valve seat 51, a float valve 52 and a float 54.

Pressure of the fuel within the vapor separator V is increased to a high pressure by a high pressure fuel pump PH and is supplied into a fuel distribution passage DA of a fuel distribution pipe D, the fuel within the fuel distribution passage DA is injected and supplied in a controlled manner toward the inside of an intake pipe 55 connected to an engine E via a fuel injection valve J attached to a fuel injection valve supporting hole DB, and the remaining fuel enters into a pressure regulator R and is again returned into the vapor separator V via a return fuel passage 56.

That is, a high pressure fuel discharged from the high pressure fuel pump PH circulates into the vapor separator V via the fuel distribution pipe D and the pressure regulator R, and a fuel flow discharged from a discharge passage PA of the high pressure fuel pump PH and reaching the fuel distribution pipe D, the pressure regulator R, the return fuel passage 56 and the vapor separator V is called as an injection fuel flow passage system A.

The vapor separator V including the high pressure fuel pump PH, the fuel distribution pipe D, the pressure regulator R and an engine E are received and arranged within a cowling C, and a propeller boss G for rotatably supporting a propeller L is provided in an end portion of a shaft K extending downward outside the cowling C from the engine E.

The engine E is cooled by a water or a seawater particularly in an internal combustion engine for an outboard machine.

The seawater is pressurized by a cooling water pump W and is supplied toward the engine E, an intake passage WA of the cooling water pump W is open to a lower position of the shaft K to suck the seawater, and the seawater having the pressure increased by the cooling water pump W is supplied into a water jacket EA of the engine E via a discharge passage WB. Further, the seawater supplied into the water jacket EA is discharged via a discharge passage EB open to the propeller boss G. The seawater is continuously supplied and discharged into the water jacket EA of the engine E in the manner mentioned above, whereby the engine is cooled.

Reference numeral 1 denotes a pilot cooling water passage, an upstream 1A thereof is branched from the discharge passage WB of the cooling water pump W, and a downstream 1B thereof is arranged at a position above the propeller L and is open to the atmosphere by a discharge hole 1C.

The pilot cooling water passage 1 is required for a driver to visually recognize that the cooling water pump W is driven when the engine E is operated. When the cooling water pump W is driven and the seawater is discharged into the discharge passage WB, a part of the seawater flowing through the discharge passage WB toward the water jacket EA flows into the pilot cooling water passage 1 and is discharged from the discharge passage 1C in the downstream 1B, so that the driver can recognize an operation of the cooling water pump W by recognizing the discharged seawater.

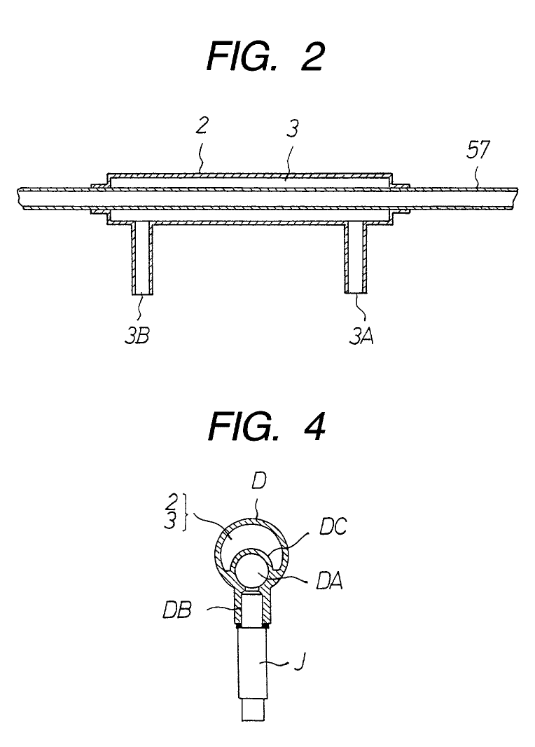

Reference numeral 2 denotes a heat exchanger arranged in a fuel stream flowing from the discharge passage PA of the high pressure fuel pump PH to the fuel distribution pipe D, the pressure regulator R, the return fuel passage 56 and the vapor separator V, that is, an injection fuel flow passage system A. An embodiment thereof is shown in FIG. 2.

In the present embodiment, the heat exchanger 2 is formed in an annular cooling water flow passage 3 extending in a longitudinal direction in such a manner as to surround an outer periphery of a fuel supply passage 57 connecting the discharge passage PA of the high pressure fuel pump PH and the fuel distribution passage DA. A cooling water introduction passage 3A and a cooling water discharge passage 3B are open to the cooling water flow passage 3, an upstream of the cooling water introduction passage 3A is connected and open to the discharge passage WB of the cooling water pump W, and a downstream of the cooling water discharge passage 3B is open to the atmosphere. The upstream of the cooling water introduction passage 3A should not be open to and communicated with the water jacket EA and the discharge passage EB.

When the engine E is operated, the cooling water pump W is synchronously driven, the seawater is sucked into the cooling water pump W via the intake passage WA, and the seawater having the increased pressure is discharged toward the discharge passage WB.

Then, the seawater having the increased pressure within the discharge passage WB is supplied into the water jacket EA so as to cool the engine E, the seawater having a temperature increased thereby is discharged toward the outside via the discharge passage EB, and the operations mentioned above are continuously performed, whereby an improved engine cooling operation can be achieved.

Further, a part of the seawater having the increased pressure within the discharge passage WB flows into the pilot cooling water passage 1 and is discharged toward the outside from the discharge hole 1C in the downstream 1B, so that the driver can know that the cooling water pump W is normally driven, by recognizing the discharge of the seawater.

On the other hand, another part of the seawater having the increased pressure within the discharge passage WB is supplied into the cooling water flow passage 3 of the heat exchanger 2 via the cooling water introduction passage 3A, the seawater within the cooling water flow passage 3 reduces a temperature of the fuel flowing within the fuel supply passage 57, and next the seawater having a temperature increased due to a temperature replacing effect within the cooling water flow passage 3 is quickly discharged to the outside from the cooling water discharge passage 3B.

Accordingly, the cooling water is continuously supplied into and discharged from the cooling water flow passage 3 and the new seawater is always supplied thereto, whereby it is possible to reduce a temperature of the fuel which is returned into the vapor separator V from the fuel supply passage 57 via the fuel distribution pipe D, the pressure regulator R and the return fuel passage 56, thereby restricting an increase of the temperature of the fuel within the vapor separator V.

As mentioned above, in accordance with the present invention, since it is possible to restrict the increase of the temperature of the fuel returning into the vapor separator V, it is possible to restrict the temperature of the fuel stored within the vapor separator V to a fixed level or less even in a case of continuous operation for a long time, whereby it ispossible to prevent a cavitation from being generated in the pump portion and it is possible to stably keep an improved pump operation.

Further, even if the motor serving as the drive portion of the high pressure fuel pump PH generates heat, the increase of the temperature of the fuel within the vapor separator V is restricted and the temperature of the fuel sucked into the pump is reduced, so that it is possible to widely reduce a generation of the bubbles within the high pressure fuel pump PH, whereby it is possible to accurately supply the fuel in a state that no bubbles is contained in the fuel injected toward the inside of the intake pipe 55 from the fuel injection valve J. Accordingly, an engine performance can be effectively stabilized.

Further, since the cooling water is supplied to the heat exchanger 2 by using the conventional cooling water pump W, no new pump is required to be prepared and a producing cost is not widely increased.

In this case, an arrangement of the heat exchanger 2 is not limited to the fuel supply passage 57, and the same operations and effects can be achieved as far as it is arranged in the injection fuel flow passage system A.

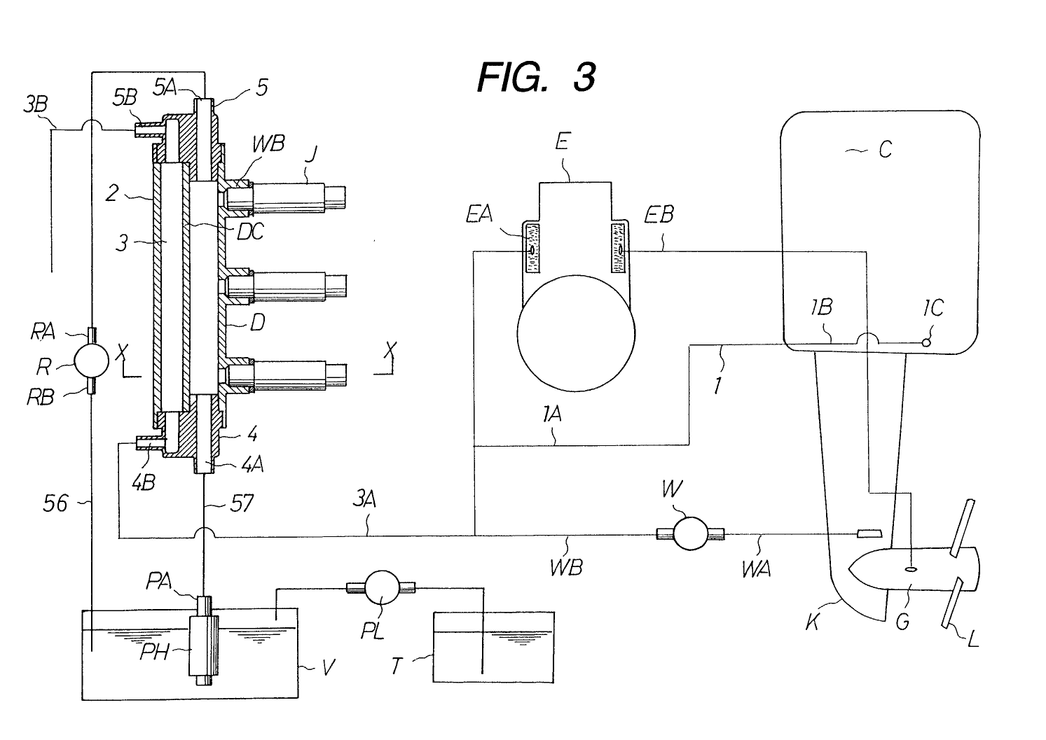

Next, a description will be given of another embodiment of the heat exchanger 2 with reference to FIG. 3.

The heat exchanger is different from that of the embodiment shown in FIG. 1. In this case, the constant liquid surface apparatus is briefly illustrated.

The heat exchanger 2 is integrally formed in the fuel distribution pipe D.

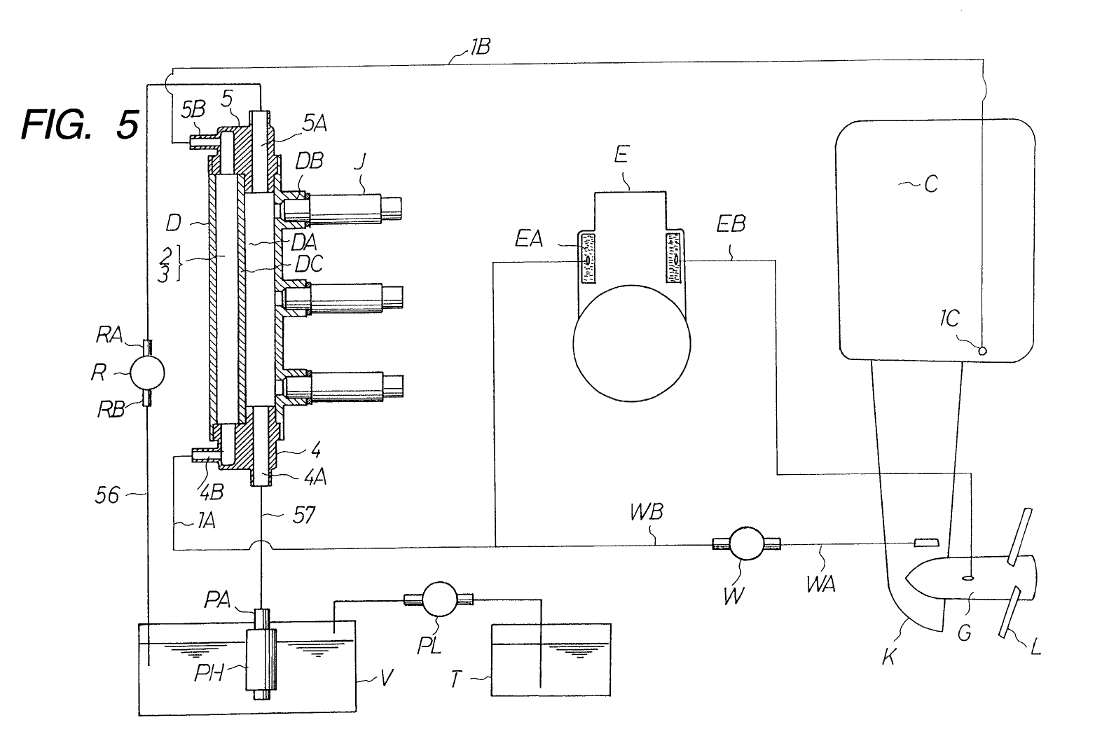

The fuel distribution pipe D is separated into a fuel distribution passage DA extending in a longitudinal direction and a cooling water flow passage 3 being in contact therewith by a wall DC, and respective openings at both ends of the fuel distribution passage DA and the cooling water flow passage 3 are closed by a first closing member 4 and a second closing member 5 in a separate manner. The separated fuel distribution passage DA and the cooling water flow passage 3 are well illustrated in FIG. 4.

A fuel inlet 4A open to the inside of the fuel distribution passage DA and a cooling water inlet 4B open to the cooling water flow passage 3 are provided in the first closing member 4, the fuel inlet 4A is connected to the fuel supply passage 57 connected to the high pressure fuel pump PH, and the cooling water inlet 4B is connected to the cooling water introduction passage 3A branched from the discharge passage WB.

Further, a fuel outlet 5A open to the inside of the fuel distribution passage DA and a cooling water outlet 5B open to the cooling water flow passage 3 are provided in the second closing member 5, the fuel outlet 5A is connected to the inlet RA of the pressure regulator R, and the cooling water outlet 5B is connected to the cooling water discharge passage 3B. In this case, reference symbol DB denotes a fuel injection valve supporting hole open to the fuel distribution passage DA.

In the structure mentioned above, the fuel having the pressure increased to the high pressure by the high pressure fuel pump PH is supplied into the fuel distribution passage DA via the fuel inflow passage 57 and the fuel inlet 4A, the fuel within the fuel distribution passage DA is injected and supplied toward the inside of the intake pipe connected to the engine E via the fuel injection valve J, and the remaining fuel is again returned into the vapor separator V via the fuel outlet 5A, the pressure regulator R and the return fuel passage 56.

On the other hand, a part of the seawater within the discharge passage WB having the pressure increased by the cooling water pump W is supplied to the cooling water flow passage 3 formed within the fuel distribution pipe D in a separate manner via the cooling water introduction passage 3A and the cooling water inlet 4B, thereby cooling the fuel within the fuel distribution passage DA so as to reduce the temperature of the fuel. The seawater having the temperature increased due to the heat replacing effect is discharged via the cooling water outlet 5B and the cooling water discharge passage 3B, and the seawater is continuously supplied to and discharged from the cooling water flow passage 3 during an operation of the engine.

In accordance with the structure mentioned above, since the cooling water flow passage 3 is provided within the fuel distribution pipe D in such a manner as to be separated from the fuel distribution passage DA, it is possible to obtain a sufficient capacity of the cooling water flow passage, whereby it is possible to effectively cool the injection fuel flow passage system A. Further, since the cooling water flow passage 3 is formed on the basis of the conventional fuel distribution pipe D, it is possible to significantly easily form the cooling water flow passage and it is possible to restrict a great increase of the producing cost.

Further, in the case that the downstream end of the cooling water discharge passage 3B is connected to the portion near the discharge hole 1C of the pilot cooling water passage 1 and the seawater is discharged from the cooling water discharge passage 3B by using the discharge hole 1C, the water is simultaneously discharged to the outside from the conventional discharge hole 1C, so that the structure is particularly preferable in view of a sense of beauty.

If a part of the pilot cooling water passage 1 is clogged, it is possible to recognize that the cooling water pump W is driven, by viewing the seawater discharged from the cooling water discharge passage 3B via the discharge hole 1C.

The other embodiment is shown in FIG. 5.

The structure is made such that the cooling water is supplied into and discharged from the cooling water flow passage 3 by using the pilot cooling water passage 1.

That is, a primary side pilot cooling water passage 1A connected to the discharge passage WB of the cooling water pump W is open to the cooling water flow passage 3, and a secondary side pilot cooling water passage 1B connected to the discharge hole AC is also open thereto.

In accordance with the structure mentioned above, the seawater having the pressure increased by the cooling water pump W is supplied to the cooling water flow passage 3 from the primary side pilot cooling water passage 1A, and the seawater within the cooling water flow passage 3 is discharged from the secondary side pilot cooling water passage 1B via the discharge hole 1C, so that the fuel within the fuel distribution passage DA is cooled by the seawater flowing through the cooling water flow passage 3, and the driver can recognize the operation of the cooling water pump W by the seawater discharged from the discharge hole 1C of the secondary side pilot cooling water passage 1B.

In accordance with the structure mentioned above, the conventional pilot cooling water passage 1 can be effectively utilized, a freedom for design of the piping system can be increased, and it is possible to effectively restrict an increase of the producing cost.

As mentioned above, in accordance with the fuel injection apparatus in the internal combustion engine for the outboard machine of the present invention, since the heat exchanger is arranged in the injection fuel flow passage system, and the cooling water branched from the discharge passage of the cooling water pump for cooling the engine is supplied to the heat exchanger via the cooling water introduction passage and is discharged toward the outside via the cooling water discharge passage, the heat exchanger is freely arranged along the injection fuel flow passage system, whereby it is possible to reduce the temperature of the fuel returning to the vapor separator and it is possible to restrict the increase of the temperature of the fuel within the vapor separator. Accordingly, it is possible to keep the pump performance of the fuel pump in a good condition and it is possible to accurately and stably supply the fuel without the bubbles being contained in the fuel injected from the fuel injection valve.

Further, in accordance with the structure made such that the inside of the fuel distribution pipe is separated into the fuel distribution passage and the cooling water flow passage, and the cooling water flow passage is connected to the cooling water introduction passage connected to the discharge passage of the cooling water pump and the cooling water discharge passage toward the outside, it is possible to increase a freedom for design of the cooling water flow passage serving as the heat exchanger and it is possible to inexpensively provide the cooling water flow passage.

Furthermore, in accordance with the structure made such that the cooling water discharge passage is connected to the portion near the discharge hole of the pilot cooling water passage for discharging the cooling water from the discharge passage of the cooling water pump toward the outside without passing through the engine, it is possible to increase a freedom for design of the cooling water discharge passage. Further, in accordance with the structure made such that the cooling water flow passage is connected to the primary side pilot cooling water passage connected to the discharge passage of the cooling water pump and the secondary side pilot cooling water passage connected to the discharge hole, the pilot cooling water passage can be used as the piping system of the cooling water flow passage, so that it is possible to further increase a freedom for design of the piping system and it is possible to restrict the increase of the producing cost.

What is claimed is:

1. A fuel injection apparatus in an internal combustion engine for an outboard machine comprising:
a high pressure fuel pump arranged within a vapor separator for storing a fixed amount of low pressure fuel supplied from a low pressure fuel pump therein; and
an injection fuel flow passage system for supplying a high pressure fuel discharged from the high pressure fuel pump to a fuel distribution pipe provided with a fuel injection valve and returning a return fuel in a pressure regulator connected to the fuel distribution pipe into the vapor separator via a return fuel passage,
wherein a heat exchanger is arranged in said injection fuel flow passage system, and a cooling water branched from a discharge passage of a cooling water pump for cooling an engine is supplied to said heat exchanger via a cooling water introduction passage and is discharged toward the outside via a cooling water discharge passage, thereby cooling the fuel flowing within the injection fuel flow passage system.

2. A fuel injection apparatus in an internal combustion engine for an outboard machine as claimed in claim 1, wherein the fuel distribution pipe constituting said injection fuel flow passage system has a fuel distribution passage, and a cooling water flow passage corresponding to a heat exchanger surrounding the fuel distribution passage, which are formed within the fuel distribution pipe in a separate manner, a fuel supply passage connected to at least the high pressure fuel pump is connected to said fuel distribution passage, an injection valve supporting hole for inserting and supporting the fuel injection valve is provided in said fuel distribution passage in an open manner, and a cooling water introduction passage connected to a discharge passage of the cooling water pump and a cooling water discharge passage toward the outside are connected to the cooling water flow passage.

3. A fuel injection apparatus in an internal combustion engine for an outboard machine as claimed in claim 2, wherein said cooling water discharge passage is connected to a portion near a discharge hole of a pilot cooling water passage which is discharged toward the outside from the discharge passage of the cooling water pump without passing through the engine.

4. A fuel injection apparatus in an internal combustion engine for an outboard machine as claimed in claim 2, wherein a primary side pilot cooling water passage connected to the discharge passage of the cooling water pump and a secondary side pilot cooling water passage connected to the discharge hole are connected to said cooling water flow passage, the cooling water is supplied to the cooling water flow passage via the primary side pilot cooling water passage, and the cooling water within the cooling water flow passage is discharged to the outside via the secondary side pilot cooling water passage.
